(19) United States
(12) Patent Application Publication
(10) Pub. No.: US 2018/0228179 A1
(43) Pub. Date: Aug. 16, 2018

(54) GLYCERIN-BASED GUMMY CANDY AND FOAM CANDY PRODUCTS WITH PROBIOTIC BACTERIA

(71) Applicant: Chr. Hansen A/S, Hoersholm (DK)

(72) Inventors: Mogens DOLMER, Humlebaek (DK); Mette WINNING, Scoeborg (DK)

(73) Assignee: Chr. Hansen A/S, Hoersholm (DK)

(21) Appl. No.: 15/580,431

(22) PCT Filed: Jun. 8, 2016
(86) PCT No.: PCT/EP2016/063006

§ 371 Date: Dec. 7, 2017

(30) Foreign Application Priority Data
Jun. 8, 2015 (EP) 15170988.8

(51) Int. Cl. A23G 3/36; A23G 3/42; A23G 3/52; A23G 3/34; A23L 33/135

(52) U.S. Cl. CPC A23G 3/366; A23G 3/42; A23G 3/52; A23G 3/0012; A23G 3/0082; A23L 33/135; A23V 2250/5072; A23V 2250/6406; A23V 2250/628; A23V 2250/28; A23V 2250/5062; A23V 2250/5024; A23V 2250/5432; A23V 2002/00

(57) ABSTRACT

The present invention relates to a glycerin-based candy product comprising probiotic bacteria, said product having a moisture content less than 9% and a water activity (a_{w}) less than 0.5 and comprising a) glycerin in an amount of 10% to 40% (w/w), b) 40% to 75% (w/w) of at least one saccharide or at least one polyol which is not glycerin, or a mixture thereof, c) at least one hydrocolloid, and d) at least one species of a probiotic bacterium. Further, the invention relates to methods for producing a glycerin-based candy product comprising probiotic bacteria.

### FIELD OF THE INVENTION

The present invention relates to glycerin-based gummy candy and foam candy products comprising probiotic bacteria and methods for producing glycerin-based gummy candy and foam candy products comprising probiotic bacteria.

### BACKGROUND OF THE INVENTION

Gummy candy, gummies and foam candy are a broad category of gelatin-based candies which may be more or less chewy.

Normal gummies are produced with high amounts of water, syrup and sugar which are boiled at a temperature up to 120° C. Afterwards gelatin, flavor and color are added—and the gummies are processed at approximately 90° C. into their final form.

Foam candy is likewise produced with high amounts of water, syrup and sugar which are boiled at a temperature up to 120° C. Afterwards gelatin, flavor and color are added—air is wiped into the mixture and the foam is processed at app. 60° C. into their final form.

Under conditions of lack of nutrition certain bacteria such as Bacilli and Clostridia are able to form endospores, a dormant, tough, non-reproductive structure. Endospores can survive without nutrients. They are resistant to ultraviolet radiation, desiccation, high temperature, extreme freezing and chemical disinfectant. Until now it has only been possible to produce gelatin-based foam candy and gummy candy products with spore-forming probiotic bacteria such as Bacilli.

In EP 1 159 951 example 6 describes a chewing gum with probiotic bacteria which comprises 67.5% xylitol, 20% gum base, 3% glycerin. The term “chewing gum” is not defined in the patent application but is generally understood to be a sweetened and flavored insoluble material (as a preparation of chicle) used for chewing (Merriam-Webster).

WO2004/014152 describes a multi-phase oral delivery system for biologically active agents comprising a matrix phase which has a final moisture content between about 10% and about 30% by weight and one or more other phases associated with the matrix phase. Probiotic bacteria are disclosed in the description but no specific examples relating to probiotic bacteria are provided. Generally a moisture content of about 10% to about 30% as in the described oral delivery system will lead to a relatively high water activity, i.e. 0.5 or higher. Consistent herewith the only water activity measurement (in Example 8) is between 0.50 and 0.55.

WO2013/001089 describes dry compositions for stabilizing probiotic bacteria and provides specific compositions which are stable without the presence of a salt of alginic acid.

In EP 1 398 369 example 5 describes soft gel capsules with probiotic bacteria. By a soft gel capsule is generally understood a soft gelatin based shell surrounding a fill material. The described soft gel capsules do not contain any saccharide or polyol other than glycerol.

EP 1 064 855 discloses food, medicine and cosmetics containing vegetables or fruits which have a Bifidobacterium proliferation promoting action and are presumed to be useful for preventing or treating various conditions.

US2014/0087049 discloses a shelf stable liquid sweetener and flavor additive having a water activity below 0.8 and that glycerol functions as a water activity reducing compound through its hygroscopic properties which reduces the vapor pressure of the liquid mixture, resulting in a lowered water activity (a_{w} value). It is further described that liquid mixtures with water activity values of less than 0.7 are not conducive for microbial growth. No lower water activity values than less than 0.7 are described.

None of these documents describe or point to a process for producing glycerin-based gummy candy or foam candy products comprising probiotic bacteria nor to the glycerin-based gummy candy or foam candy products comprising probiotic bacteria of the present invention.

### SUMMARY OF THE INVENTION

By substituting most of the water present in a candy product with glycerin, it is possible to reduce the water activity (a_{w}) in the final product from normally 0.6-0.9 to less than 0.5 while maintaining similar features (texture, sweetness, taste and appearance) as conventional water-based candy products.

In some embodiments of the glycerin-based candy product the probiotic bacteria and other heat and moisture sensitive ingredients are incorporated into the candy matrix at a temperature of 50° C. to 60° C. An example of such product is a glycerin-based foam candy product.

In other embodiments of the invention, the probiotic bacteria are placed as one or more tablets/granulates (one large tablet or many small tablets/granulates) on the surface of the glycerin-based candy product. Examples of such products are gummies as well as foam candy products.

In a yet further embodiment of the invention, the probiotic bacteria are placed as one or more tablets/granulates (one large tablet or many small tablets/granulates) between two or more layers of glycerin-based candy matrix. The candy matrix may be gummy candy or foam candy or combinations thereof.

### DETAILED DISCLOSURE OF THE INVENTION

In its broadest context the present invention relates to a gummy candy or foam candy product comprising probiotic bacteria, said product having a water activity (a_{w}) less than 0.5 and comprising
a) at least one polyol,
b) at least one saccharide,
c) at least one hydrocolloid, and
d) at least one species of a probiotic bacterium.

In some embodiments the present invention relates to a glycerin-based candy product comprising probiotic bacteria, said product having a water activity (a_{w}) less than 0.5 and comprising
a) glycerin in an amount of 10% to 40% (w/w),
b) 40% to 75% (w/w) of at least one saccharide or at least one polyol which is not glycerin, or a mixture thereof,
c) at least one hydrocolloid, and
d) at least one species of a probiotic bacterium.

The term “glycerin-based candy composition” which in the present specification and claims is used interchangeably with “glycerin-based candy product” comprises glycerin-based gummy candy, foam candy and combinations thereof. Examples of such products are soft foam and hard foam candy, foam gum, marshmallow, wine gum, fruit gum, gummies, jelly or jellies, and the like.

The glycerin-based candy product or composition of the invention is semi-solid at room temperature.

In one embodiment the glycerin-based candy product or composition of the invention comprises the probiotic bacteria dispersed in the candy matrix. A such product can be considered a single phase product.

In other embodiments, the glycerin-based candy product or composition of the invention comprises two or more phases such as three, four, five or more phases which may be layers of glycerin-based candy matrix and tablets or granulates comprising probiotic bacteria. In these embodiments, the probiotic bacteria may be present in one or more of the phases or layers. It is presently preferred that the probiotic bacteria are present in one of the phases only. In a further embodiment one species of probiotic bacteria is present in one phase and another species of probiotic bacteria is present in another phase. The phase(s) not comprising probiotic bacteria may be inert or comprise one or more other active ingredients as described in further detail in the following.

Examples of such embodiments are described in the examples. Example 1 describes a glycerin-based foam candy product containing Bifidobacterium animalis subsp lactis evenly distributed into the foam candy product.

Example 2 describes a glycerin-based foam candy product containing Bifidobacterium animalis subsp lactis and Lactobacillus acidophilus evenly distributed into the foam candy product.

Example 3 describes a glycerin and fructo-oligosaccharide (FOS) based foam candy product with added tablets of Bifidobacterium animalis subsp lactis and Lactobacillus rhamnosus on the surface of the foam candy product.

Example 4 describes a glycerin, xylitol and inulin based foam candy product containing Bifidobacterium animalis subsp lactis distributed into the foam candy product.

Example 5 describes a glycerin-based gummy candy product with added tablets of Bifidobacterium animalis subsp lactis and Lactobacillus rhamnosus on the surface of the gummy candy product and further the addition of a second gummy layer upon the tablets—incorporating the tablets between two layers of glycerin-based gummy.

Example 6 describes a glycerin-based foam candy product containing Bifidobacterium animalis subsp lactis and Lactobacillus acidophilus evenly distributed into the foam candy product and further the addition of a gummy layer upon the glycerin-based foam candy product.

Example 7 describes a glycerin and maltodextrin based foam candy product containing Bifidobacterium animalis subsp lactis and Lactobacillus rhamnosus evenly distributed into the foam candy product.

Example 8 describes a glycerin-based foam candy product with tablets of Bifidobacterium animalis subsp lactis and Lactobacillus rhamnosus between two layers of the foam candy product.

Further examples could be combinations of Examples 5 and 8 with a gummy product on one side and a foam candy product on the other side and tablet(s) in between.

Example 9 describes a glycerin-based foam candy product containing Bifidobacterium animalis subsp lactis evenly distributed into the foam candy product.

The glycerin-based candy product or composition of the invention is substantially dissolvable in water in contrast to chewing gum which by definition comprises a substantial amount of substances such as gum base which are insoluble in water. By the term “insoluble” is meant that less than 0.1 g per 100 mL of solvent such as water can be dissolved.

Preferably, the glycerin-based candy product or composition comprises no more than 5% (w/w) insoluble substances, such as no more than 4% (w/w) insoluble substances, no more than 3% (w/w) insoluble substances, no more than 2% (w/w) insoluble substances, no more than 1% (w/w) insoluble substances, e.g. no more than 0.5% (w/w) insoluble substances.

In some embodiments, the glycerin-based candy product or composition of the invention is substantially digestible. In other embodiments the glycerin-based candy product or composition of the invention comprises one or more oligo- or polysaccharides which can be only partially digested by humans, such as fructo-oligosaccharides (FOS), galactooligosaccharides (GOS) and inulin, as discussed in further detail later. In some embodiments the water activity (a_{w}) is less than 0.4, such as less than 0.3, e.g. no more than 0.2. In some embodiments the water activity (a_{w}) is in the range of 0.1-0.3, e.g. in the range of 0.1-0.2.

Probiotic bacteria are live microorganisms and this can be a challenge during production and formulation of final dosage forms. Probiotic bacteria are especially sensitive towards temperature, moisture content, and other ingredients in a formulation matrix. Using a low production temperature and water activity ensure the survival of the probiotic bacteria during production and storage of the product.

Water activity (a_{w}) is defined as the partial vapor pressure of water in a composition at a specified temperature divided by the standard state partial vapor pressure of water at the same temperature. Water activity thus acts as a measure of the amount of free (i.e. unbound) water in a composition. It may be calculated as:

a_{w}=p/p₀

where p is the partial vapor pressure of water in the composition and p₀ is the vapor pressure of pure water at the same temperature.

Alternatively, water activity may be calculated as:

a_{w}=l_{w}x_{w}

where l_{w} is the activity coefficient of water and x_{w} is the mole fraction of water. The two calculations above which define a_{w} are equivalent.

Water activity may be measured by methods known to those skilled in the art, for example as done in the present examples with a Novasina LabMaster & LabPartner at 20° C.

The water activity, a_{w}, measures the water which is free to be utilized by the bacteria. As will be known by the person skilled in the art, the moisture content refers to the total water, the quantity of water contained in a material.

The moisture content may be calculated by summing up the quantity of water contained in the various ingredients of the product and dividing with the weight of the product. For practical purposes the moisture content can be measured with a Sartorius Moisture Meter MA 35 (thermogravimetric moisture meter) and ensuring conditions where all water is evaporated. Generally, this may be accomplished by setting the temperature to 130° C. and the time to 20 minutes.

The moisture content of the glycerin-based candy product (free water+bound water i.e. water bound in cells and gelatin) is preferably less than 9%. More preferably, the moisture content of the glycerin-based candy product or composition of the invention is no more than 8% (w/w), such as no more than 7% (w/w), no more than 6% (w/w), no more than 5% (w/w), no more than 4% (w/w), no more than 3% (w/w), e.g. no more than 2% (w/w).

Glycerin (glycerol; propane-1,2,3-triol) is a colorless, odorless, viscous liquid that is widely used in pharmaceutical formulations. Glycerol has three hydroxyl groups that are responsible for its solubility in water and its hygroscopic nature. The glycerol backbone is central to all lipids known as triglycerides. Glycerol is sweet-tasting and generally considered non-toxic.

Glycerin is preferably present in an amount in the range of 10% to 40% (w/w) of the composition. In some embodiments, the glycerin is present in an amount of 15% to 35% (w/w) of the composition, such as 20% to 30% (w/w) of the composition.

The composition may further comprise at least one polyol which is not glycerin. When the term “polyol” is used in the present specification and claims reference is meant to be such other polyols.

In some embodiments, the composition comprises at least one saccharide or at least one polyol. In other embodiments, the composition comprises a mixture of at least one saccharide and at least one polyol.

The saccharide may be a mono-, di-, oligo- or polysaccharide, or a mixture of at least two saccharides. The composition may even comprise three, four or more saccharides. In some embodiments, the composition comprises a mixture of at least one mono- or disaccharide and at least one oligosaccharide. In other embodiments, the composition comprises a mixture of at least one mono- or disaccharide and at least one polysaccharide.

In further embodiments, the composition comprises a mixture of at least one mono-, di-, oligo- or polysaccharide and at least one polyol. In some embodiments, the composition comprises a mixture of at least one monosaccharide and at least one polyol. In other embodiments, the composition comprises a mixture of at least one disaccharide and at least one polyol. In yet other embodiments, the composition comprises a mixture of at least one oligosaccharide and at least one polyol. In further embodiments, the composition comprises a mixture of at least one polysaccharide and at least one polyol.

Monosaccharides useful in the composition of the present invention include glucose (also known as dextrose), fructose and galactose. The table or granulated sugar most customarily used is sucrose, a disaccharide. In the body, sucrose hydrolyses into fructose and glucose.

Disaccharides useful in the composition of the present invention include among other sucrose, maltose and lactose. Presently preferred mono- or disaccharides according to the present invention are sucrose, glucose, fructose and galactose. The composition may comprise one or more mono- or disaccharides, such as one, two or three or even more different saccharides.

In one embodiment, the at least one saccharide is a disaccharide such as sucrose. In some embodiments, the sucrose is powdered, also called confectioner's sugar or icing sugar. In the examples made by adding icing sugar, the texture of the products are much alike gelatin-based candy products.

In some embodiments the composition of the invention comprises at least one oligosaccharide. An oligosaccharide is a saccharide polymer containing three to nine monosaccharides. Fructo-oligosaccharides (FOS), which are found in many vegetables, consist of short chains of fructose molecules. Galactooligosaccharides (GOS), which also occur naturally, consist of short chains of galactose molecules. These compounds can be only partially digested by humans. The composition may comprise one, two or even more different oligosaccharides.

In some embodiments the composition of the invention comprises at least one polysaccharide. Polysaccharides are polymeric carbohydrate molecules composed of more than ten monosaccharide units bound together by glycosidic linkages and on hydrolysis give the constituent monosaccharides or oligosaccharides. They range in structure from linear to highly branched. Examples include storage polysaccharides such as starch, maltodextrin and inulin. The composition may comprise one, two, three or even more different polysaccharides.

Inulin is a heterogeneous collection of fructose polymers. It consists of glucosyl moiety and fructosyl moiety, which are linked by β(2,1) bonds, having a degree of polymerization from 10 to 60.

The addition of oligo- or polysaccharides such as FOS, GOS, inulin and other polysaccharides can assist in reduction of the water activity and has the further advantage that oligo- and polysaccharides are not quite as sweet as mono- and disaccharides and further that they add fibers to the composition.

Polyols (sugar alcohols) have the general formula HOCH2(CHOH)nCH2OH. They are commonly added to foods because of their lower caloric content and less sweetness than sugars. Furthermore they are not broken down by bacteria in the mouth or metabolized to acids, and thus do not contribute to tooth decay.

The composition may further comprise at least one polyol such as erythriol, inositol, isomalt, mannitol, maltitol, sorbitol, or xylitol, or a mixture thereof. Preferred polyols are xylitol, sorbitol and mannitol. The composition may comprise one, two, three or even more different polyols.

Appropriate organoleptic properties of the glycerin-based candy products are generally most easily obtained by using powdered or finely grinded dry ingredients. It is particularly important that the at least one saccharide and/or at least one polyol are powdered as these constitute a major part of the composition.

The at least one saccharide and/or at least one polyol which is not glycerin, or a mixture thereof, constitute up to 80% (w/w) of the composition. In some embodiments, the at least one saccharide and/or at least one polyol which is not glycerin, or a mixture thereof, constitutes 40% to 75% (w/w). In other embodiments the at least one saccharide and/or at least one polyol which is not glycerin, or a mixture thereof, constitutes 50% to 70% (w/w) of the composition. If more than one saccharide and/or polyol which is not glycerin is used, the ratio can vary depending on how many and which saccharide(s) or polyol(s) are used.

A hydrocolloid is defined as a colloid system wherein the colloid particles are hydrophilic polymers dispersed in water. Many hydrocolloids are derived from natural sources. For example, gelatin is produced by hydrolysis of proteins of mammalian and fish origins, and pectin is extracted from citrus peel and apple pomace.

Hydrocolloids are employed in gummies and foam gum mainly to influence texture or viscosity. Preferred hydrocolloids according to the present invention are gelatin, pectin, and agar, or a mixture thereof. Other hydrocolloids which may be used in the composition of the present invention are xanthan gum, guar gum, locust bean gum, cellulose derivatives as carboxymethyl cellulose among others. The hydrocolloid(s) is/are dissolved in as little water as possible in order to obtain a water activity (a_{w}) less than 0.5 in the final composition.

In the present invention a gelatin having a Bloom strength in the range of 100-300, such as at least 180, at least 190, e.g. at least 200 is preferred. It is presently preferred that the gelatin has a Bloom strength in the range of 200-300, more preferably 220-290, even more preferably 240-290 Bloom as a high Bloom strength makes it possible to use a minimum of water.

The glycerin-based candy product or composition of the invention comprises at least one species of a probiotic bacterium. In a preferred embodiment, the probiotic bacteria are non-spore-forming bacteria.

Examples of such probiotic bacteria are Lactococcus, Lactobacillus, Pediococcus, and Streptococcus and more preferably at least one species selected from the group consisting of Bifidobacterium spp., Bifidobacterium breve, Bifidobacterium animalis, Bifidobacterium lactis, Bifidobacterium longum, Bifidobacterium bifidum, Lactococcus lactis, Lactococcus cremoris, Lactobacillus acidophilus, Lactobacillus casei, Lactobacillus kefir, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sake, Lactobacillus reuteri, Lactobacillus lactis, Lactobacillus delbreuckii, Lactobacillus plantarum, Lactobacillus johnsonii and Streptococcus thermophilus.

Particularly preferred strains are Bifidobacterium animalis subsp lactis, e.g. the strains deposited as DSM 15954 (marketed by Chr. Hansen A/S, Denmark, as BB-12®); ATCC 27536, and DSM 10140, respectively; Lactobacillus acidophilus, e.g. the strain deposited as DSM 13241, Lactobacillus rhamnosus, e.g. the strain deposited as ATCC 53103, Lactobacillus paracasei subsp. paracasei, e.g. the strains deposited as ATCC 55544 and CCTCC M204012, respectively, Lactobacillus reuteri, e.g. the strain deposited as ATCC 55845, Lactobacillus rhamnosus, e.g. the strain deposited as ATCC 55826, Lactobacillus paracasei, e.g. the strain deposited as LMG-P-17806, Streptococcus thermophilus, e.g. the strain deposited as DSM 15957, and Lactobacillus fermentum, e.g. the strain deposited as NM02/31074.

Combinations of several species or strains of probiotic bacteria can be used, i.e. 2, 3, 4, 5, 6, 7, 8, 9, 10, 11, 12, 13, 14, 15, 16, 17, 18, 19, 20, 21, 22, 23, 24, 25 or even more of the above listed species and strains. In presently preferred embodiments, only one, two, three, four or five different strains are present in the composition according to the invention. For products comprising probiotic bacteria it is common practice to mention the number of probiotic bacteria at the time of manufacture and/or at the end of shelf life.

By the term “viable” is meant that the cell is alive and capable of forming a colony in a petri dish during pour plating or spread plating. The number of viable probiotic bacteria is determined as the number of colony forming units (CFU) by pour plate or spread plate methods with incubation under conditions suitable for growth of the probiotic strain(s). By this method cells capable of growing and forming colonies will be counted. When a number is given in the present specification and claims, it should be understood as CFU/g unless the context indicates otherwise. Preferably, the glycerin-based candy product of the present invention comprises more than 1×10E9 CFU/unit at end of shelf life (EOS). The end of shelf life is at least 3 months, such as at least 6 months, at least 9 months, at least 12 months, at least 18 months, most preferably at least 24 months. The glycerin-based candy product of the present invention will generally have a weight between 0.5 and 10 g per unit which means that it is possible to add the necessary amount of probiotic bacteria to obtain the desired CFU at the end of shelf life even under storage at room temperature.

In addition to the probiotic bacteria, one or more other active ingredients, for example one, two, three, four or more active ingredients selected from the group consisting of vitamins such as vitamin A, D, E, K₁, K₂, C, B₂, B₆, B₁₂, biotin, niacin, folic acid; minerals such as zinc, selenium, chromium, copper, calcium, chloride or a herbal extract could be included in glycerin-based composition.

The composition may further comprise at least one flavor, flavor enhancer, color, acid, or sweetener.

The present invention further relates to a method for preparing a composition comprising probiotic bacteria, said composition having a water activity (a_{w}) less than 0.5, wherein said method comprising mixing
a) glycerin,
b) at least one saccharide or at least one polyol, or a mixture thereof,
c) at least one hydrocolloid, and adding
d) at least one species of a probiotic bacterium.

In one embodiment of the present invention, a mixture of glycerin and at least one saccharide or at least one polyol, or a mixture thereof, is heated to a temperature of 80-120° C., and then cooled to approximately 80° C.

At least one hydrocolloid is dissolved in as little water as possible at a temperature of approximately 90° C. and mixed with the mixture of glycerin and at least one saccharide and/or at least one polyol.

In one embodiment of the invention the mixture of glycerin, at least one saccharide or at least one polyol, or a mixture thereof, and at least one hydrocolloid is cooled down to a temperature of 50 to 60° C., and the at least one species of a probiotic bacterium is added as dry powder into the composition e.g. by mixture to ensure evenly distribution of the probiotics. As will be evident to a person of skill in the art the mixing is to take place when the mixture has an appropriate viscosity and the appropriate temperature will thus depend on the choice of hydrocolloid, e.g. the choice of gelatin and Bloom strength. It is presently completed that both porcine, bovine and fish gelatins will be useful and that the mixing make take place at a temperature in the range of 40 to 70° C., such as 50 to 60° C., e.g. about 65° C.

In another embodiment of the invention the mixture of glycerin, at least one saccharide or at least one polyol, or a mixture thereof, and at least one hydrocolloid is cooled down to a temperature of not more than 65° C., and at least one species of a probiotic bacterium is added to the surface of the composition while the composition is still sticky. The at least one probiotic bacterium may be present in one or more tablets or granulate.

In some embodiments, the mixing takes place under low oxygen and/or dry air, e.g. by using carbon dioxide or nitrogen. Also the further handling and storage should preferably take place under dry conditions such as less than 35% RH, preferably less than 30% RH, most preferably less than 25% RH, even more preferably less than 20% RH, such as less than 15% RH.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### EXAMPLES

### Materials and Methods

Excipients:

| | | | |
|---|---|---|---|
| Glycerin | | Min. 99.5% purity | Verbio |
| Icing sugar | Finely ground | App. 99.8% purity | Nordic Sugar |
| | sugar without | | |
| | the addition of | | |
| | anti-caking | | |
| | agents | | |
| Citric Acid E330 | Citric Acid | Min. 99.5% | Merck KGaA |
| | E330 | | |
| Gelatin | Gelatin Bloom | | Rousselot |
| | 225 PS | | |
| Inulin | Orafti ® GR | | Beneo Orafti |
| Fructo- | Actilight ® | | Tereos Syral |
| Oligosaccharide | 950P | | |
| (FOS) | | | |

Flavors:

| | | |
|---|---|---|
| Raspberry | Raspberry flavour | Silesia Gerhard Hanke GMBH & KG |
| Exotic | Natural Flavour, | TAKASAGO Europe Gmbh |
| | type Exotic | |
| Orange | Orange Flavour | Silesia Gerhard Hanke GMBH & KG |
| Lemon | Lemon Flavour | Silesia Gerhard Hanke GMBH & KG |
| Strawberry | Strawberry flavour | Silesia Gerhard Hanke GMBH & KG |
| Orange | ORANGE | Firmenich SA |
| | FLAVOR 055605 | |
| | TP0551 | |
| Cranberry | Cranberry Flavor | IFF inc. |
| | powder | |

Colors:

| | | |
|---|---|---|
| DragonFruit 301 | Fruitmax Dragonfruit 301 WS | Chr. Hansen Natural |
| | | Colors A/S |
| Yellow 400 | Sweetcolor Yellow 400 WS | Chr. Hansen Natural |
| | | Colors A/S |
| Yellow 302 | Sweetcolor Yellow 302 WS | Chr. Hansen Natural |
| | | Colors A/S |
| Orange 220 | Sweetcolor Orange 220 WS | Chr. Hansen Natural |
| | | Colors A/S |
| Mandarin | Mandarin 100 WSSP | Chr. Hansen Natural |
| | | Colors A/S |
| Orange | I-Color Orange 700 WSS-P | Chr. Hansen Natural |
| | | Colors A/S |

Probiotic Bacteria:

Bifidobacterium animalis subsp lactis

Lactobacillus rhamnosus

Lactobacillus acidophilus

Tablet I:

A probiotic tablet (Ø16 mm 3 mm thick) consisting of xylitol, microcrystalline cellulose, magnesium stearate, glyceryl behenate, Bifidobacterium animalis subsp lactis, and Lactobacillus rhamnosus.

Tablet II:

Small probiotic tablets (Ø3 mm, app. 2.5 mm thick) consisting of xylitol, microcrystalline cellulose, magnesium stearate, glyceryl behenate, Bifidobacterium animalis subsp lactis, and Lactobacillus rhamnosus.

### Example 1

Preparation of Foam Gum with Icing Sugar and Probiotic Bacteria

Mixture A:

118 g glycerin and 295 g icing sugar are heated to 80-120° C.

Mixture B:

12 g water (80° C.) and 8 g gelatin are mixed and kept at app. 80° C.

Mixture A is cooled to app. 80° C. and 1.5 g Orange flavor, 2.5 g Citric Acid and 2 g Sweetcolor Yellow 400 are added. Mixture A is mixed thoroughly with a hand mixer with increasing speed for 2-5 minutes. Mixture B is added and intensive mixing is continued incorporating air into a combined mixture C which is then cooled down.

Mixture D:

25 g icing sugar and 10 g Bifidobacterium animalis subsp lactis

When Mixture C has cooled down to 55° C., 35 g of mixture D is added under continued mixing to ensure evenly distribution of the probiotic bacteria.

The resulting foam gum is poured or molded into the preferred shape and size and allowed to stand for minimum 1 day.

The water activity in the final foam gum is measured to 0.21.

### Example 2

Preparation of Foam Gum with Inulin and Probiotic Bacteria

Mixture A:

100 g glycerin and 250 g icing sugar are heated to 80-120° C.

Mixture B:

12 g water (80° C.) and 8 g gelatin are mixed and kept at app. 80° C.

Mixture A is cooled to app. 80° C. and flavor, acid and color are added. Mixture A is mixed thoroughly with a mixer. Mixture B is added and intensive mixing is continued incorporating air into a combined mixture C while the mixture is cooling down.

Mixture D:

50 g inulin, 10 g Bifidobacterium animalis subsp lactis and 10 g Lactobacillus acidophilus

When Mixture C has cooled down to app. 55° C., Mixture D is added under mixing to ensure evenly distribution of the probiotic bacteria.

The resulting foam gum is poured or molded into the preferred shape and size and allowed to stand for minimum 1 day.

The water activity in the final foam gum is measured to 0.17.

### Example 3

Preparation of Foam Gum with FOS, Icing Sugar and Probiotic Bacteria

Mixture A:

100 g glycerin, 125 g FOS and 125 g icing sugar are heated to 80-120° C.

Mixture B:

8 g water (80° C.) and 12 g gelatin are mixed and kept at app. 80° C.

Mixture A is cooled to app. 80° C. and flavor, acid and color are added. Mixture A is mixed thoroughly with a mixer. Mixture B is added and intensive mixing is continued incorporating air into a combined mixture C which is then cooled down.

When Mixture C reaches 65° C. additional 30 g of FOS is added under mixing. The foam gum is poured or molded into the preferred shape and size and allowed to stand for minimum 1 day.

Variation I:

Tablet I is attached to the surface of the foam gum, when the foam is still sticky and allowed to stand for minimum 1 day.

Variation II:

A number of tablets II are attached to the surface of the foam gum, when the foam is still sticky and allowed to stand for minimum 1 day.

### Example 4

Preparation of Foam Gum with Glycerol, Xylitol, Inulin and Probiotic Bacteria

Mixture A:

77 g glycerin and 234 g xylitol are heated to app. 100° C.

Mixture B:

9 g water (80° C.) and 6 g gelatin are mixed and kept at app. 80° C.

Mixture A is cooled to app. 80° C. and 2 g Raspberry flavor, 3 g citric acid and 2 g DragonFruit 301 (natural color) are added. Mixture A is mixed thoroughly with a mixer. Mixture B is added and intensive mixing is continued incorporating air into a combined mixture C which is then cooled down.

Mixture D:

25 g inulin and 25 g Bifidobacterium animalis subsp lactis

When Mixture C has cooled down to app. 55° C., Mixture D is added under mixing to ensure evenly distribution of the probiotic bacteria.

The resulting foam gum is poured or molded into the preferred shape and size and allowed to stand for minimum 1 day.

The water activity in the final foam gum is measured to 0.21.

### Example 5

Preparation of gummies with icing sugar and probiotic bacteria

Mixture A:

120 g glycerin and 300 g icing sugar are heated to 80-120° C.

Mixture B:

15 g water (80° C.) and 10 g gelatin are mixed and kept at app. 80° C.

Mixture A is cooled to app. 80° C. and 2 g Orange flavor, 3.8 g Citric Acid and 2 g Sweetcolor Yellow 400 are added. Mixture B is added and all added ingredients are gently mixed with minimal incorporating of air into a combined mixture C. The resulting gummy is poured or molded into the preferred shape at a temperature of 70-80° C. and allowed to cool further.

The water activity in the final gum without tablets attached is measured to 0.23.

Variation I:

Tablet I is attached to the surface of the gum, when the gum is still sticky, and the gum is allowed to stand for minimum 1 day.

Variation II:

A number of tablets II are attached to the surface of the gum, when the gum is still sticky, and the gum is allowed to stand for minimum 1 day.

Variation III:

A number of tablets II are attached to the surface of the gum, when the gum is still sticky, and the gum is allowed to cool further down.

After 30-60 minutes of cooling a new mixture of gummy is added on top of the first layer thereby incorporating the tablets between two layers of gummy, and the gummy candy is allowed to stand to cool further down.

Variation IV:

Tablet I is attached to the surface of the gum, when the gum is still sticky and allowed to cool further down.

After 30-60 minutes of cooling a new mixture of gummy is added on top of the first layer thereby incorporating the tablet between two layers of gummy, and the gummy candy is allowed to stand to cool further down.

### Example 6

Preparation of Foam Gum with Icing Sugar and Probiotic Bacteria

Mixture A:

94 g glycerin and 250 g icing sugar are heated to 80-120° C.

Mixture B:

A mixture of 8 g water, 8 g glycerin (80° C.) and 12 g gelatin (Bloom 270-290) are mixed and kept at app. 80° C.

Mixture A is cooled to app. 80° C. and 1 g Cranberry flavor and 1.5 g Citric Acid are added (no color added to this version). Mixture A is mixed thoroughly with a hand mixer with increasing speed for 2-5 minutes. 14.3 g of Mixture B is added and intensive mixing is continued incorporating air into a combined mixture C which is then cooled down.

Mixture D:

15 g icing sugar, 2.5 g Bifidobacterium animalis subsp lactis and 21.5 g Lactobacillus acidophilus

When Mixture C has cooled down to app. 63° C., mixture D is added under continued mixing to ensure evenly distribution of the probiotic bacteria.

The resulting foam gum is poured or molded into the preferred shape and size and cooled and allowed to stand for minimum 1 day.

The water activity in the final foam gum is measured to 0.08.

CFU/g has been measured after production to 4.2E+09 and again after app. 3 months of storage at 5° C. to 4.9E+09. Hence no reduction of cell count has been seen for this product during storage.

### Example 7

Preparation of Foam Gum with Icing Sugar, Maltodextrin and Probiotic Bacteria

Mixture A:

95 g glycerin and 250 g icing sugar are heated to 80-120° C.

Mixture B:

A mixture of 8 g water, 8 g glycerin (80° C.) and 12 g gelatin (Bloom 270-290) are mixed and kept at app. 80° C.

Mixture A is cooled to app. 80° C. and 0.5 g Orange flavor, 1.56 g Citric Acid and 0.82 g color are added. Mixture A is mixed thoroughly with a hand mixer with increasing speed for 2-5 minutes. 9 g of Mixture B is added and intensive mixing is continued incorporating air into a combined mixture C which is then cooled down.

Mixture D:

20 g Maltodextrin, 10 g Bifidobacterium animalis subsp lactis and 15 g Lactobacillus rhamnosus.

When Mixture C has cooled down to 60° C., 40 g of mixture D is added under continued mixing to ensure evenly distribution of the probiotic bacteria.

The resulting foam gum is poured or molded into the preferred shape and size and cooled and allowed to stand for minimum 1 day in dry atmosphere.

The water activity in the final foam gum is measured to 0.13.

### Example 8

Preparation of Foam Gum with Icing Sugar and Probiotic Bacteria

Mixture A:

190 g glycerin, 500 g icing sugar and 3 g Citric Acid are heated to 80-120° C.

Mixture B:

16 g water and 16 g glycerin are blended and heated (80° C.), 24 g gelatin is added and mixed, and the resulting mixture is kept at app. 80° C.

Mixture A is cooled to app. 80° C. and 24 g of Mixture B is added and all added ingredients are gently mixed.

100 g icing sugar, 1 g cranberry flavor and 1 g color are added and mixed to incorporate air into a combined mixture C.

The resulting hard foam gummy is poured or molded into a number of units in the preferred shape (but each mold is only filled app. half) at a temperature of 70-80° C. and allowed to cool.

App. 6 small tablets (tablet II) are attached to the surface of the individual foam gum, when the temperature of the foam is below app. 35° C. but still a little sticky.

After app. 30 minutes of cooling a similar hard foam gum is prepared and added on top of the existing hard foam gum with the small tablets so that the small tablets are incorporated between the two layers of hard foam gummy.

The foam candy product is allowed to stand to cool further down in dry atmosphere.

The water activity in the final product is measured to app. 0.13.

After production the total CFU/g in the product is 5.6 E+09 CFU/g, and after 6 months of storage at 25° C./60% RH the total CFU/g is measured to 1.2 E+09 CFU/g.

### Example 9

Preparation of Foam Gum with Icing Sugar and Probiotic Bacteria

Mixture A:

120 g glycerin and 329 g icing sugar are heated to 80-120° C.

Mixture B:

A mixture of 16 g water (80° C.) and 12 g gelatin (Bloom 270-290) are mixed and kept at app. 80° C.

Mixture A is cooled to app. 80° C. and 0.5 g Orange flavor, 2 g Citric Acid and 2 g color (Mandarin 100) are added. Mixture A is mixed thoroughly with a hand mixer with increasing speed for 2-5 minutes. 18.5 g of Mixture B is added and intensive mixing is continued incorporating air into a combined mixture C which is then cooled down.

Mixture D:

20 g icing sugar and 8 g Bifidobacterium animalis subsp lactis

When Mixture C has cooled down to app. 60° C., mixture D is added under continued mixing to ensure evenly distribution of the probiotic bacteria.

The resulting foam gum is poured or molded into the preferred shape and size and cooled and allowed to stand for minimum 1 day in dry atmosphere.

The water activity in the final foam gum is measured to 0.20.

The total water content calculated is 2.1%. When measured with an Sartorius Moisture Meter MA 35 (thermogravimetric moisture meter), where the temperature is set to 130° C. and the time is set for 20 minutes, the dry mater content is 97.86% equal to 2.1% water content.

The total CFU/g after production of the foam gum is 8.6 E+08 CFU/g.

### REFERENCES

EP 1 159 951
WO2004/014152
WO2013/001089
EP 1 398 369
EP 1 064 855
US2014/0087049

1-15. (canceled)

16. A glycerin-based gummy candy, foam candy, or combination thereof, comprising:
(a) glycerin in an amount of 10% to 40% (w/w),
(b) 40% to 75% (w/w) of at least one saccharide or at least one polyol which is not glycerin, or a mixture thereof,
(c) at least one hydrocolloid, and
(d) at least one species of a probiotic bacterium,
wherein the candy has a moisture content of less than 9% and a water activity (a_{w}) of less than 0.5.

17. The candy according to claim 16, wherein the at least one saccharide is a monosaccharide, disaccharide, oligosaccharide, or polysaccharide, or a mixture of at least two saccharides.

18. The candy according to claim 17, wherein the at least one saccharide is a disaccharide.

19. The candy according to claim 18, wherein the disaccharide is sucrose.

20. The candy according to claim 16, wherein the at least one saccharide comprises a mixture of at least one monosaccharide or disaccharide and at least one oligosaccharide or polysaccharide.

21. The candy according to claim 16, wherein the at least one saccharide comprises a mixture of at least one monosaccharide, disaccharide, oligosaccharide or polysaccharide, and at least one polyol which is not glycerin.

22. The candy according to claim 17, wherein the at least one oligosaccharide is a fructo-oligosaccharide (FOS) or galactooligsaccharide (GOS).

23. The candy according to claim 17, wherein the at least one polysaccharide is inulin.

24. The candy according to claim 17, wherein the at least one polyol is one or more of erythriol, inositol, isomalt, mannitol, maltitol, sorbitol, and xylitol.

25. The candy according to claim 16, wherein the at least one hydrocolloid is one or more of gelatin, pectin, and agar.

26. The candy according to claim 16, further comprising one or more of a flavor, flavor enhancer, color, acid, sweetener, vitamin, mineral, and herbal extract.

27. The candy according to claim 16, wherein the probiotic bacteria are dispersed in a single phase candy matrix.

28. The candy according to claim 16, comprising two or more phases, wherein probiotic bacteria are dispersed in one or more of the phases.

29. The candy according to claim 28, further comprising one or more of a vitamin, mineral, and herbal extract dispersed in one or more of the phases.

30. A method for preparing a glycerin-based gummy candy, foam candy or combination thereof, comprising mixing:
(a) glycerin in an amount of 10% to 40% (w/w),
(b) 40% to 75% (w/w) of at least one saccharide or at least one polyol which is not glycerin, or a mixture thereof,
(c) at least one hydrocolloid, and
adding (d) at least one species of a probiotic bacterium,
wherein the candy has a moisture content of less than 9% and a water activity (a_{w}) of less than 0.5.

31. The method according to claim 30, wherein the mixing is performed under low oxygen and/or dry air.

32. The method according to claim 30, wherein the at least one species of probiotic bacterium is incorporated into the candy or provided on the surface of the candy.
